(19) United States
(12) Patent Application Publication
(10) Pub. No.: US 2007/0108066 A1
(43) Pub. Date: May 17, 2007

(54) VOLTAGE MODE CURRENT CONTROL

(75) Inventors: Stan D. Tsai, Fremont, CA (US); Lakshmanan Karuppiah, San Jose, CA (US)

Correspondence Address: FISH & RICHARDSON P.C., P.O. BOX 1022, MINNEAPOLIS, MN, 55440-1022, US

(73) Assignee: APPLIED MATERIALS, INC., Santa Clara, CA (US)

(21) Appl. No.: 11/553,438

(22) Filed: Oct. 26, 2006

Related U.S. Application Data
(60) Provisional application No. 60/731,656, filed on Oct. 28, 2005.

(51) Int. Cl. B23H 3/00

(52) U.S. Cl. 205/641; 451/5

(57) ABSTRACT

Methods and apparatus for voltage-mode current control. A computer implemented method includes: (a) commencing a ECMP polishing step on a conductive film of a substrate; (b) setting a current output voltage of a voltage source, the current output voltage being set in accordance with a recipe for the ECMP polishing step; (c) measuring current flow through the conductive film; (d) calculating, based on the measured current flow, a current polishing rate; (e) determining whether an adjustment to the current output voltage is needed, the determining being based on a target polishing rate; and (f) when an adjustment is determined to be needed, calculating and effecting the adjustment to the current output voltage.

### CROSS-REFERENCE TO RELATED APPLICATIONS

This application claims the benefit of priority of U.S. Provisional Application Ser. No. 60/731,656, filed on Oct. 28, 2005, which is incorporated by reference herein.

### BACKGROUND

The present invention relates generally to electrochemical mechanical polishing of substrates.

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulative layer to fill the trenches or holes in the insulative layer. After planarization, the portions of the conductive layer remaining between the raised pattern of the insulative layer form vias, plugs, and lines that provide conductive paths between thin film circuits on the substrate. For other applications, such as oxide polishing, the filler layer is planarized until a predetermined thickness is left over the non planar surface. In addition, planarization of the substrate surface is usually required for photolithography.

Chemical mechanical polishing (CMP) is one suitable method of planarization. This planarization method typically requires that the substrate be mounted on a carrier or polishing head. The exposed surface of the substrate is typically placed against a rotating polishing disk pad or belt pad. The polishing pad can be either a standard pad or a fixed abrasive pad. A standard pad has a durable roughened surface, whereas a fixed-abrasive pad has abrasive particles held in a containment media. The carrier head provides a controllable load on the substrate to push it against the polishing pad. A polishing slurry is typically supplied to the surface of the polishing pad. The polishing slurry includes at least one chemically reactive agent and, if used with a standard polishing pad, abrasive particles.

Electrochemical Mechanical Polishing (ECMP) is another suitable method for planarization. ECMP generally removes conductive materials from a substrate surface by electrochemical dissolution while concurrently polishing the substrate with reduced mechanical abrasion, as compared to CMP. Electrochemical dissolution is performed by applying a bias between a cathode and a substrate surface, which behaves as an anode, to remove conductive materials from the substrate surface into a surrounding electrolyte. The bias may be applied to the substrate surface by a conductive contact disposed on or through a polishing material upon which the substrate is processed. A mechanical component of the polishing process is performed by providing relative motion between the substrate and the polishing material that enhances the removal of the conductive material from the substrate.

Copper, for example, is one conductive material that may be polished using electrochemical mechanical polishing. Typically, copper is polished utilizing a two-step process. In the first step, the bulk of the copper is removed, typically leaving some copper residue projecting above the substrate's surface. The copper residue is then removed in a second, or over-polishing, step.

### SUMMARY

In one general aspect, the invention features a computer-implemented method that includes: (a) commencing a ECMP polishing step on a conductive film of a substrate; (b) setting a current output voltage of a voltage source, the current output voltage being set in accordance with a recipe for the ECMP polishing step; (c) measuring current flow through the conductive film; (d) calculating, based on the measured current flow, a current polishing rate; (e) determining whether an adjustment to the current output voltage is needed, the determining being based on a target polishing rate; and (f) when an adjustment is determined to be needed, calculating and effecting the adjustment to the current output voltage.

In another general aspect, the invention features a computer program product that is tangibly stored on machine readable medium. The product comprises instructions operable to cause a substrate processing station to perform a method comprising: (a) commencing a ECMP polishing step on a conductive film of a substrate; (b) setting a current output voltage of a voltage source, the current output voltage being set in accordance with a recipe for the ECMP polishing step; (c) measuring current flow through the conductive film; (d) calculating, based on the measured current flow, a current polishing rate; (e) determining whether an adjustment to the current output voltage is needed, the determining being based on a target polishing rate; and (f) when an adjustment is determined to be needed, calculating and effecting the adjustment to the current output voltage.

In another general aspect, the invention features a ECMP system that includes a biasing loop configured to bias a conductive film in a substrate being processed. The system includes a power source operable to provide an output voltage to the biasing loop. The system includes a current measurement device operable to measure current flow through the conductive film. The system includes a computing system operable to: commence a ECMP polishing step on the substrate; set a current output voltage of the power source, the current output voltage being set in accordance with a recipe for the ECMP polishing step; cause the current measurement device to measure current flow through the conductive film; calculate, based on the measured current flow, a current polishing rate; determine whether an adjustment to the current output voltage is needed, the determining being based on a target polishing rate; and when an adjustment is determined to be needed, calculate and effect the adjustment to the current output voltage.

Possible advantages of implementations of the invention can include one or more of the following. Methods and systems in accordance with the invention provides benefits of both voltage mode and current mode of process control and improves process consistency.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 depicts a processing station for ECMP.

FIG. 2 is a partial sectional view of one implementation of a platen and processing pad assembly.

FIG. 3 is a circuit diagram of a circuit loop for biasing in ECMP.

FIG. 4 shows a flowchart of a method for RTPC voltage-mode current control.

FIG. 5 shows an example of a current-voltage diagram.

Like reference numbers and designations in the various drawings indicate like elements.

### DETAILED DESCRIPTION

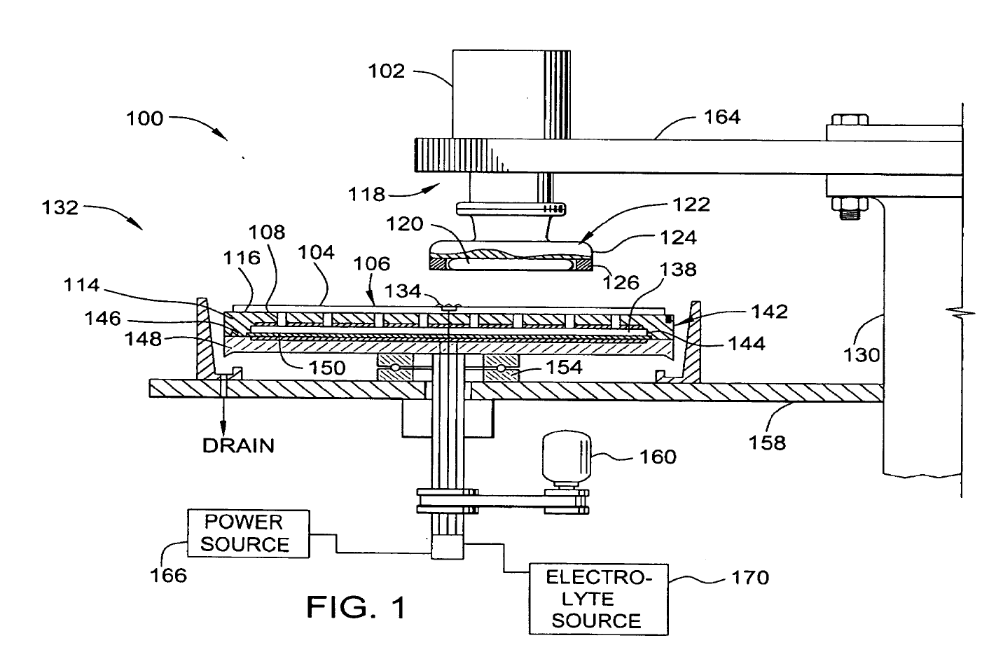

FIG. 1 depicts a sectional view of a processing station 100 configured to perform ECMP in accordance with the invention. The processing station 100 includes a carrier head assembly 118 adapted to hold a substrate 120 against a platen assembly 142 in an ECMP station 132. Relative motion is provided therebetween to process (for example, polish or deposit material on) the substrate 120. The relative motion can be rotational, lateral, or some combination thereof and can be provided by either or both of the carrier head assembly 118 and the platen assembly 142. The exposed outer surface of the substrate that is processed includes a conductive film.

In one implementation, the carrier head assembly 118 is supported by an arm 164 coupled to a base 130 and which extends over the ECMP station 132. The ECMP station may be coupled to or disposed proximately to the base 130.

The carrier head assembly 118 can include a drive system 102 coupled to a carrier head 122. The drive system 102, which can include, for example, a motor, generally provides at least rotational motion to the carrier head 122. The carrier head 122, or a substrate mounting component within the carrier head 122, additionally can be actuated to move toward a processing pad assembly 106 situated on the platen assembly 142 such that the substrate 120 retained in the carrier head 122 can be pushed against a processing surface 104 during processing.

Examples of a suitable carrier head include TITAN HEAD™ or TITAN PROFILER™ available from Applied Materials, Inc., of Santa Clara, Calif. Generally, the carrier head 122 includes a housing 124 and retaining ring 126 that define a center recess in which the substrate 120 is retained. The retaining ring 126 circumscribes the substrate 120 disposed within the carrier head 122 to prevent the substrate from slipping out from under the carrier head 122 while processing. It is contemplated that other carrier heads may be utilized.

The ECMP station 132 generally includes a platen assembly 142 rotationally disposed on a base 158. A bearing 154 is disposed between the platen assembly 142 and the base 158 to facilitate rotation of the platen assembly 142 relative to the base 158. The platen assembly 142 is typically coupled to a motor 160 that provides the rotational motion to the platen assembly 142.

The platen assembly 142 has an upper plate 114 and a lower plate 148. The upper plate 114 can be fabricated from a rigid material, for example, a metal or rigid plastic. In one implementation, the upper plate 114 is fabricated from or coated with a dielectric material such as chlorinated polyvinyl chloride (CPVC). The upper plate 114 can have a circular, rectangular or other planar form. A top surface 116 of the upper plate 114 supports the processing pad assembly 106. The processing pad assembly 106 can be held to the upper plate 114 of the platen assembly 142 by magnetic attraction, static attraction, vacuum, adhesives, or the like.

The lower plate 148 is generally fabricated from a rigid material, such as aluminum and may be coupled to the upper plate 114 by any conventional means, such as a plurality of fasteners (not shown). Generally, a plurality of locating pins 146 (one is shown in FIG. 1) is disposed between the upper and lower plates 114, 148 to ensure alignment therebetween. The upper plate 114 and the lower plate 148 may optionally be fabricated from a single, unitary member.

A plenum 138 is defined in the platen assembly 142 and may be partially formed in at least one of the upper or lower plates 114, 148. In the embodiment depicted in FIG. 1, the plenum 138 is defined in a recess 144 partially formed in the lower surface of the upper plate 114. At least one hole 108 is formed in the upper plate 114 to allow electrolyte, provided to the plenum 138 from an electrolyte source 170, to flow through the platen assembly 142 and into contact with the substrate 120 during processing. The plenum 138 is partially bounded by a cover 150 coupled to the upper plate 114 enclosing the recess 144. Alternatively, the electrolyte may be dispensed from a pipe (not shown) onto the top surface of the processing pad assembly 106.

At least one contact assembly 134 is disposed on the platen assembly 142 along with the processing pad assembly 106. Each contact assembly 134 extends at least to or beyond the upper surface of the processing pad assembly 106 and is adapted to electrically couple the substrate 120 to a power source 166. The processing pad assembly 106 is coupled to a different terminal of the power source 166 so that an electrical potential may be established between the substrate 120 and processing pad assembly 106.

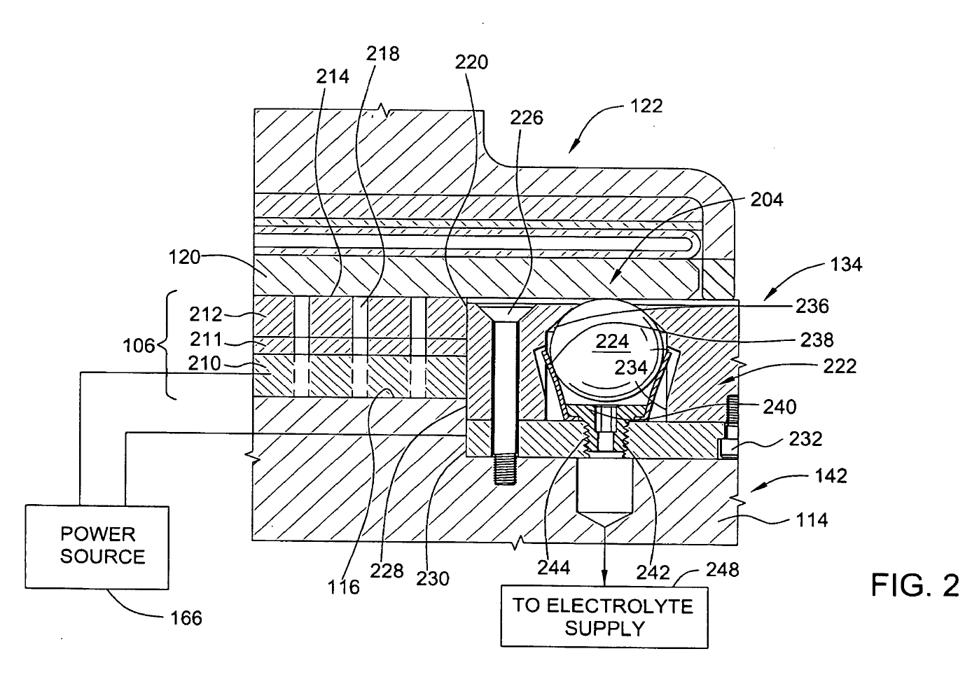

FIG. 2 depicts a partial sectional view of one implementation of the processing pad assembly 106 and contact assembly 134 shown in FIG. 1. The processing pad assembly 106 is zoned and includes at least a conductive lower layer, or electrode, 210 and a non-conductive upper layer 212. In the implementation depicted in FIG. 2, an optional subpad 211 is disposed between the upper and lower layers, 210, 212. The optional subpad 211 may be used in any of the embodiments of the zoned processing pad assembly discussed herein. The subpad 211 and layers 210, 212 of the zoned processing pad assembly 106 are combined into a unitary assembly by the use of adhesives, bonding, compression molding, or the like.

The subpad 211 is typically fabricated from a material softer, or more compliant, than the material of the upper layer 212. The difference in hardness or durometer between the upper layer 212 and the subpad 211 may be chosen to produce a desired polishing/plating performance. The subpad 211 may also be compressive. Examples of suitable subpad 211 materials include, but are not limited to, foamed polymer, elastomers, felt, impregnated felt and plastics compatible with the processing chemistries.

The conductive lower layer 210 is disposed on the top surface 116 of the upper plate 114 of the platen assembly 142 and is coupled to the power source 166 through the platen assembly 142. The lower layer 210 is typically comprised of a conductive material, such as stainless steel, copper, aluminum, gold, silver and tungsten, among others. The lower layer 210 may be solid, impermeable to electrolyte, permeable to electrolyte, perforated, or a combination thereof. In the embodiment depicted in FIG. 2, the lower layer 210 is configured to allow electrolyte flow therethrough.

One or more permeable passages, for example, permeable passage 218, can be disposed at least through the upper layer 212 and extend at least to the lower layer 210. Alternatively, the passage 218 can extend completely through the upper layer 212 and the lower layer 210 (as shown in phantom). The passage 218 allows an electrolyte to establish a conductive path between the substrate 120 and the lower layer 210. The passage 218 can include a permeable portion of the upper layer 212. The passage 218 can be a hole formed in the upper layer 212.

The upper layer 212 can be fabricated from polymeric materials compatible with process chemistry, examples of which include polyurethane, polyearbonate, fluoropolymers, PTFE, PTFA, polyphenylene sulfide (PPS), or combinations thereof, and other processing materials used in substrate processing surfaces. In one implementation, a processing surface 214 of the upper layer 212 of the zoned processing pad assembly 106 is dielectric, for example, polyurethane or other polymer.

At least one aperture 220 is formed in the layers 210, 212 and optional subpad 211 of the zoned processing pad assembly 106. Each aperture 220 is of a size and location to accommodate a contact assembly 134 disposed therethrough. In one embodiment, there is a single aperture 220 formed in the center of the processing pad assembly 106 to accommodate a single contact assembly 134.

A contact element 238 of the contact assembly 134 that is disposed on the upper layer 114 of the platen assembly 142 is coupled to the power source 166. Although only one contact assembly 134 is shown coupled to the upper layer 114 of the platen assembly 142 in FIG. 2, any number of contact assemblies 134 may be utilized and may be distributed in any number of configurations on the upper layer 114 of the platen assembly 142.

The contact assembly 134 can include a ball assembly 204 that is generally coupled to the upper plate 114 of the platen assembly 142 and extends at least partially through the aperture 220 formed in the zoned processing pad assembly 106. The ball assembly 204 includes a housing 222 that retains a plurality of balls 224 (one shown in FIG. 2).

The housing 222 is removably coupled to the upper layer 114 of the platen assembly 142 to facilitate replacement of the ball assembly 204 after a number of processing cycles. The housing 222 can be coupled to the upper layer 114, for example, by a plurality of screws 226. The housing 222 includes an upper housing 228 coupled to a lower housing 230 that retain the balls 224 therebetween. The upper housing 228 is fabricated from a dielectric material compatible with process chemistries. In one embodiment, the upper housing 228 is made of PEEK. The lower housing 230 is fabricated from a conductive material compatible with process chemistries. The lower housing 230 can be made, for example, of stainless steel. The lower housing 230 is coupled to the power source 166. The housings 228, 230 may be coupled in any number of methods, including but not limited to, screwing, bolting, riveting, bonding, staking and clamping, among others. In the embodiment depicted in FIG. 2, the housings 228, 230 are coupled by a plurality of screws 232.

The balls 224 are movably disposed in a plurality of apertures 234 formed through the housings 228, 230, and may be disposed in a first position having at least a portion of the balls 224 extending above the processing surface 214 and at least a second position (shown in FIG. 2) where the balls 224 are flush with the processing surface 214. An upper portion of each of the apertures 234 includes a seat 236 that extends into the aperture 234 from the upper housing 228. The seat 236 is configured to prevent the ball 224 from exiting the top end of the aperture 234.

A contact element 238 is disposed in each aperture 234 to electrically couple the ball 224 to the lower housing 230. Each of the contact elements 238 are coupled to the lower housing 230 by a respective clamp bushing 240. In one embodiment, a post 242 of the clamp bushing 240 is threaded into a threaded portion 244 of the aperture 234 formed through the housing 222. The balls 224 are made of conductive material and are electrically coupled through the contact element 238 and the lower housing 230 to the power source 166 for electrically biasing the substrate 120 during processing.

An electrolyte source 248 provides electrolyte through the apertures 234 and into contact with the substrate 120 during processing. During processing, the balls 224 disposed within the housing 222 are actuated towards the processing surface 214 by at least one of spring, buoyant or flow forces. The balls 224 electrically couple the substrate 120 to the power source 166 through the contact elements 238 and lower housing 230. Electrolyte, flowing through the housing 222 provides a conductive path between the lower layer 210 and biased substrate 120 thereby driving an electrochemical polishing (or plating) process.

Operations of the above-described station are typically controlled by a computing system (not shown). The computing system, for example, can control an amount of force that pushes the substrate 120 against the pad assembly 106, the speed of rotation at which the drive system 102 rotates the substrate 120, and the output voltage and/or output current of the power source 166.

As noted above, the processing station 100 can apply an electrical bias to the substrate. In addition to the implementation described above in which the upper layer of the processing pad assembly is non-conductive and the lower layer is conductive, a variety of other implementations are available to effect electrical biasing of the substrate. For example, the non-conducting upper layer can include one or more embedded electrodes, for example, wires that are conductive. The electrodes are connected to the power source and form part of the bias loop. At least a portion of the electrodes projects above the polishing surface of the upper layer and/or is exposed on the polishing surface of the upper layer so as to contact and bias the substrate during polishing. In another alternative implementation, the upper layer is conductive. In another implementation, the polishing layer itself is conductive and applies the bias. For example, the processing pad assembly can include a conductive polishing layer with a polishing surface, a non-conductive backing layer, and a counter-electrode layer that abuts the surface of the platen. The conductive polishing layer can be formed by dispersing conductive fillers, such as fibers or particles (including conductively coated dielectric fibers and particles) through the polishing pad. The conductive fillers can be carbon-based materials, conductive polymers, or conductive metals, e.g., gold, platinum, tin, or lead. A voltage difference can be applied between the conductive polishing layer and the counter-electrode layer by a power source.

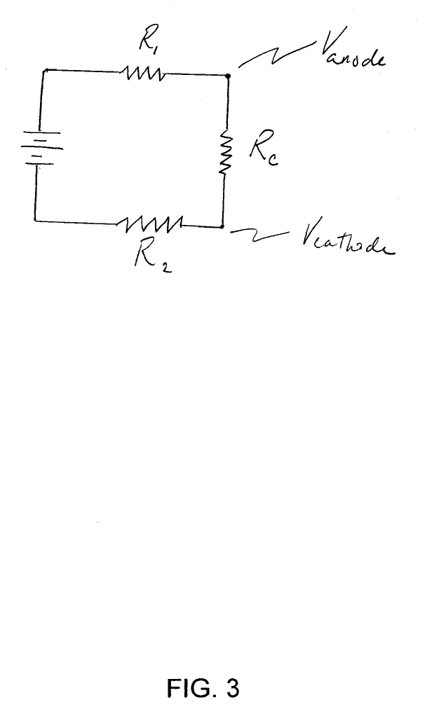

FIG. 3 shows a circuit diagram that is representative of the loop for biasing the substrate 120. The loop includes the power source 166. The loop includes a resistor, R₁, that represents the resistance between the power source 166 output and the substrate surface being processed, a resistor, R_{c}, that represents the contact resistance between the substrate surface being polished and the cathode (i.e., the above-described contacts situated in the pad assembly 106), and a resistor, R₂, that represents the contact resistance between the cathode and the power source 166. V_{anode} is the voltage at the substrate surface being processed (i.e., the anode). V_{cathode} is the voltage at the contacts (i.e., the cathode).

ECMP systems can implement techniques that provide feedback control in real time. Such techniques are referred to in the instant specification as real time process control or RTPC. RTPC of ECMP can be implemented in voltage mode or, alternatively, in current mode.

With voltage mode, the potential difference between the substrate surface being processed and the cathode is being controlled. Referring to FIG. 3, V_{anode} (which determines at least in part the removal rate and is critical to process) is equal to the output voltage of the power source (which is being controlled by the computing system control) minus I*R_{c} minus V_{cathode}. With I being equal to 15 amps, a small variation in contact R_{c} (e.g., 20 mΩ) results in a change in potential across the cathode and anode of 0.3V, which will be directly translated to variation in V_{anode}. A variation of 0.3 volts in V_{anode} will cause significant current/removal rate variation. Removal rate variation of this nature can be observed as within wafer removal rate drifting, as well as wafer-to-wafer, pad-to-pad and tool-to-tool variation.

With current mode, the current flowing between the control substrate surface being processed and the cathode is being controlled. Since removal rate is proportional to current, current mode guarantees removal rate consistency wafer-to-wafer, pad-to-pad and tool-to-tool. However, as a response to variation in contact resistance during polish, voltage spikes are usually observed. The spikes cause metal pull-out defects on wafers, which are detrimental to proper interconnects.

Each of the above-described modes has its advantages and disadvantages. Conventional voltage mode provides ease of use but is typically susceptible to drift of removal rate. Conventional current mode provides consistency in removal rate but is susceptible to voltage spikes. Current control in voltage mode of RTPC combines the advantages of both voltage mode and current mode while avoids the disadvantages of each. That is, running at voltage mode avoids severe voltage spikes, and using current feedback as a process control provides consistent removal rate.

Voltage mode current control can be operated in many different modes. In one implementation, the computing system can have access to various current-voltage curves for different processes and chemistries. In a process recipe, one sets a target removal rate, in addition to platen rpm and download forces, instead of a desired voltage in current ECMP recipe. In executing the recipe, the computing device looks into the database and starts the polishing with an initial power source output voltage, V1. Current feedback is collected during the next 2-5 seconds and provided to the computing system, which compares the feedback with the appropriate one of the current-voltage curves to decide if the polish rate is as desired. If the polish rate is less than desired, depending on the magnitude, a second higher power source output voltage, V2, is set to run the next 2-5 seconds. Feedback is again collected and compared with the current-voltage curve and correction on voltage is made continuously over the entire period of polishing until a pre-set desired charge is accumulated. Alternatively the described control can be effected for only a portion of the period of polishing. For example, in the case where current change is part of a residue clearing process, the described voltage-mode current control process can be used for the first part of the polishing until break through, at which point a significant current drop is observed for a set voltage.

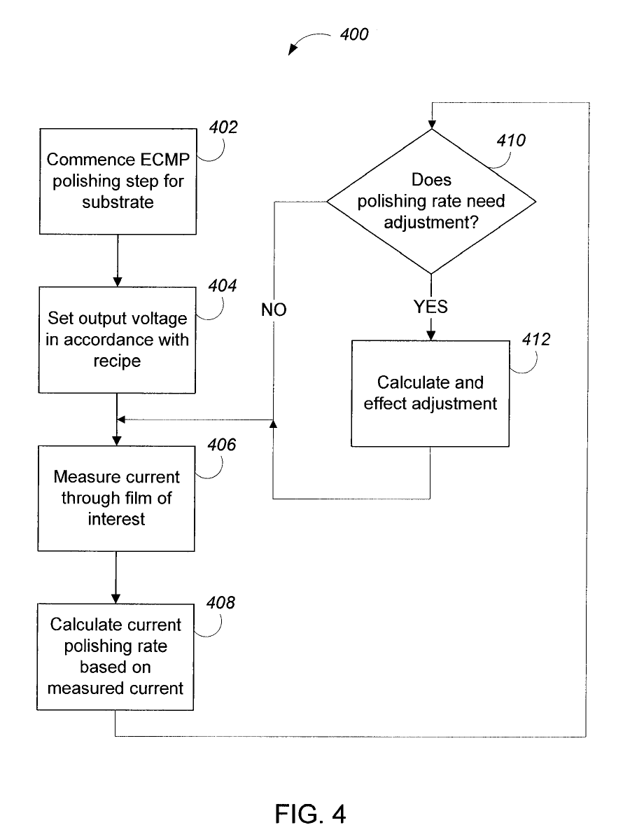

FIG. 4 shows a method 400 for voltage-mode current control. A ECMP polishing step is commenced to process a substrate surface (step 402). Polishing can be effected by the above described station 100.

The computing system sets an initial output voltage of the power source (step 404). The voltage is set in accordance with a recipe that specifies output voltage as a function of time or platen rotation.

Current flowing through the substrate surface is measured (step 406). Measurements can be effected for a period of time, for example, 2 to 5 seconds.

The computing system calculates, based on the measured current, the polishing rate (step 408). As discussed above, removal rate is proportional to current flowing through the substrate and, hence, can be calculated from the current. In one implementation, the relationship between current flowing through the substrate and removal rate is assumed to be linear or approximately linear, and a coefficient (which can be empirically derived) is used to calculate removal rate from the current.

The computing system determines whether the polishing rate needs to be adjusted (step 410). Adjustment is determined to be required if the calculated polishing rate does not satisfy criteria, one of which, for example, can specify a target polishing rate. For example, the determination can be effected by comparing the polishing rate calculated in step 408 to a target polishing rate specified by the recipe for the polishing step. In ECMP polishing steps that implement more than one removal rate, the current removal rate is compared to the appropriate target removal rate, for example, one specified by the recipe for the current time or platen revolution.

If adjustment is determined to be required, then the computing system calculates, based on the measured current and a current-voltage curve, the new output voltage of the power source (step 412). If the current removal rate is determined to be too low, for example, lower than the target removal rate, then a higher output voltage is used. If on the other hand, removal rate is determined to be too high, then a lower output voltage is used. In one implementation, the new output voltage is calculated by calculating the current from the target removal rate, and then using the calculated current and an appropriate current-voltage curve (for example, one for the particular chemistry being used by the particular processing station) to determine output voltage. In another implementation, the output voltage is incremented by a pre-determined amount, either up or down as appropriate. Subsequent measurements of current will then provide feedback on whether the incremental change was sufficient.

If adjustment is determined not to be required, then the computing system repeats steps 406, 408, and 410 as appropriate until the polishing step is completed or until voltage-mode current control is set to end.

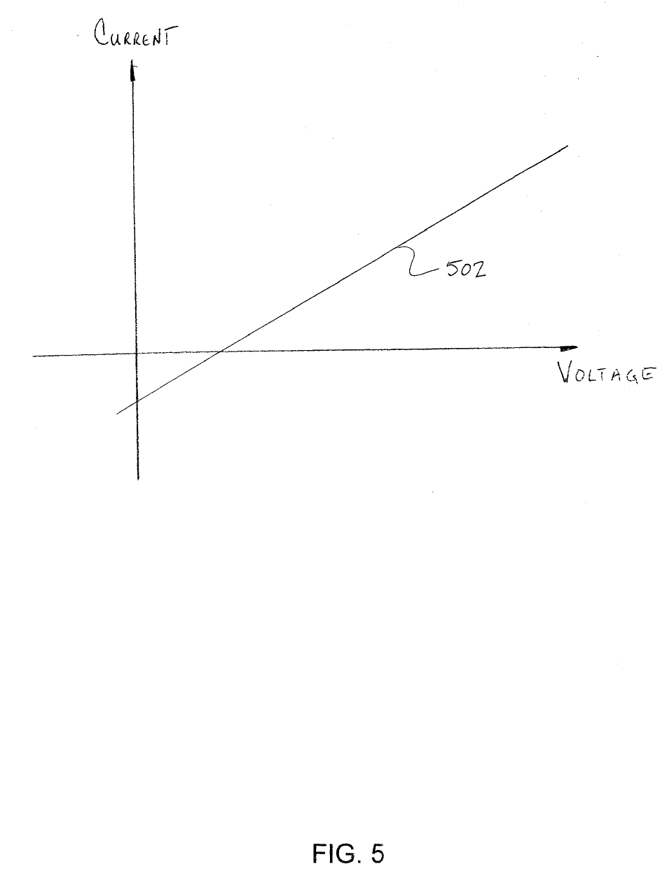

FIG. 5 shows an example of a current-voltage curve. A current-voltage curve is particular to the processing station and the chemistry of the polishing solution being used. The curve 502 depicted is a line, and voltage can be determined given a current.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

The above described polishing apparatus and methods can be applied in a variety of polishing systems. Either the polishing pad, or the carrier head, or both can move to provide relative motion between the polishing surface and the substrate. For example, the platen may orbit rather than rotate. The polishing pad can be a circular (or some other shape) pad secured to the platen. Some aspects of the endpoint detection system may be applicable to linear polishing systems, e.g., where the polishing pad is a continuous or a reel-to-reel belt that moves linearly. The polishing layer can be a standard (for example, polyurethane with or without fillers) polishing material, a soft material, or a fixed-abrasive material. Terms of relative positioning are used; it should be understood that the polishing surface and substrate can be held in a vertical orientation or some other orientation.

Particular embodiments of the invention have been described. Other embodiments are within the scope of the following claims. For example, the actions recited in the claims can be performed in a different order and still achieve desirable results. The described voltage-mode current control can be effected for all or only part of a polishing step. The described process can be implemented to remove conductive materials other than copper.

What is claimed is:

1. A computer implemented method comprising:
(a) commencing a ECMP polishing step on a conductive film of a substrate;
(b) setting a current output voltage of a voltage source, the current output voltage being set in accordance with a recipe for the ECMP polishing step;
(c) measuring current flow through the conductive film;
(d) calculating, based on the measured current flow, a current polishing rate;
(e) determining whether an adjustment to the current output voltage is needed, the determining being based on a target polishing rate; and
(f) when an adjustment is determined to be needed, calculating and effecting the adjustment to the current output voltage.

2. The method of claim 1, further comprising:
when an adjustment is determined not to be needed, waiting for an interval and then repeating steps (c)-(e).

3. The method of claim 1, wherein:
steps (c)-(e) and, when appropriate, step (f) are periodically repeated only during an initial portion of the ECMP polishing step and are not performed during a later portion of the ECMP polishing step.

4. The method of claim 1, wherein:
steps (c)-(e) and, when appropriate, step (f) are periodically repeated for the entire duration of the ECMP polishing step.

5. The method of claim 1, wherein:
calculating the adjustment is effected based on a current-voltage curve for the ECMP polishing step.

6. A computer program product, tangibly stored on machine readable medium, the product comprising instructions operable to cause a substrate processing station to perform a method comprising:
(a) commencing a ECMP polishing step on a conductive film of a substrate;
(b) setting a current output voltage of a voltage source, the current output voltage being set in accordance with a recipe for the ECMP polishing step;
(c) measuring current flow through the conductive film;
(d) calculating, based on the measured current flow, a current polishing rate;
(e) determining whether an adjustment to the current output voltage is needed, the determining being based on a target polishing rate; and
(f) when an adjustment is determined to be needed, calculating and effecting the adjustment to the current output voltage.

7. The product of claim 6, wherein the method further comprises:
when an adjustment is determined not to be needed, waiting for an interval and then repeating steps (c)-(e).

8. The product of claim 6, wherein:
steps (c)-(e) and, when appropriate, step (f) are periodically repeated only during an initial portion of the ECMP polishing step and are not performed during a later portion of the ECMP polishing step.

9. The product of claim 6, wherein:
steps (c)-(e) and, when appropriate, step (f) are periodically repeated for the entire duration of the ECMP polishing step.

10. The product of claim 6, wherein:
calculating the adjustment is effected based on a current-voltage curve for the ECMP polishing step.

11. A ECMP system, comprising:
a biasing loop configured to bias a conductive film in a substrate being processed;
a power source operable to provide an output voltage to the biasing loop;
a current measurement device operable to measure current flow through the conductive film; and
a computing system operable to:
(a) commence a ECMP polishing step on the substrate;
(b) set a current output voltage of the power source, the current output voltage being set in accordance with a recipe for the ECMP polishing step;
(c) cause the current measurement device to measure current flow through the conductive film;
(d) calculate, based on the measured current flow, a current polishing rate;
(e) determine whether an adjustment to the current output voltage is needed, the determining being based on a target polishing rate;
(f) when an adjustment is determined to be needed, calculate and effect the adjustment to the current output voltage.

12. The system of claim 11, wherein the computing device is further operable to:
when an adjustment is determined not to be needed, waiting for an interval and repeating steps (c)-(e).

13. The system of claim 1 1, wherein:
the computing system is operable to perform and repeat periodically steps (c)-(e) and, when appropriate, step (f) only during an initial portion of the ECMP polishing step and not during a later portion of the ECMP polishing step.

14. The system of claim 11, wherein:
the computing system is operable to repeat steps (c)-(e) and, when appropriate, step (f) for the entire duration of the ECMP polishing step.

15. The system of claim 11, wherein:
calculating the adjustment is effected based on a current-voltage curve for the ECMP polishing step.
